(19) United States
(12) Patent Application Publication
(10) Pub. No.: US 2026/0202515 A1
(43) Pub. Date: Jul. 16, 2026

(54) DYNAMIC HANDLING OF RELEVANT LIDAR LAYERS DEPENDING ON DEGREE OF PERTURBATION

(71) Applicant: Valeo Schalter und Sensoren GmbH, Bietigheim-Bissingen (DE)

(72) Inventors: Thomas Heitzmann, Troy, MI (US); Romain Demarets, Troy, MI (US)

(21) Appl. No.: 19/024,753

(22) Filed: Jan. 16, 2025

(51) Int. Cl. G01S 7/48; G01S 7/497; G01S 17/42; G01S 17/931

(52) U.S. Cl. CPC G01S 7/4808; G01S 7/497; G01S 17/42; G01S 17/931

(57) ABSTRACT

A method performed by a controller of a vehicle includes obtaining slope information corresponding to a slope of a roadway, obtaining, for each layer of a plurality of layers of at least one sensor configured to emit laser signals into an environment around the vehicle, a respective distance d corresponding to a distance between the at least one sensor and a point on the slope targeted by the layer, identifying, based on the respective distances d associated with the plurality of layers, one or both of a selected layer and an unselected layer, performing one or more perception functions using sensor data corresponding to any identified selected layers without using sensor data corresponding to the unselected layer, and controlling at least one function of the vehicle based on results of the one or more perception functions.

### TECHNICAL FIELD

The present disclosure relates to systems and methods for using light detection and ranging (LiDAR) sensors to monitor vehicle surroundings.

### BACKGROUND

Vehicles may be equipped with various features to monitor the environment around the vehicle, such as by capturing and recording images of the environment. In some examples, LiDAR sensors are used to monitor the environment around the vehicle for autonomous driving tasks, semi-autonomous driving tasks, and/or providing driver assistance during non-autonomous driving.

LiDAR sensors may be used for various driving tasks by providing localization (e.g., identifying a position and orientation of the vehicle in a real-world space), perception (e.g., identifying and tracking objects in the environment around the vehicle), and other functions. For example, LiDAR sensors target objects or surfaces in the environment with a laser and measure an amount of time for reflected light to return to the LiDAR sensors. Typically, LiDAR sensors implement algorithms that are calibrated in accordance with a known situation or environment, parameters, etc.

### SUMMARY

A method performed by a controller of a vehicle includes obtaining slope information corresponding to a slope of a roadway, obtaining, for each layer of a plurality of layers of at least one sensor configured to emit laser signals into an environment around the vehicle, a respective distance d corresponding to a distance between the at least one sensor and a point on the slope targeted by the layer, identifying, based on the respective distances d associated with the plurality of layers, one or both of a selected layer and an unselected layer, performing one or more perception functions using sensor data corresponding to any identified selected layers without using sensor data corresponding to the unselected layer, and controlling at least one function of the vehicle based on results of the one or more perception functions.

In an embodiment, a system is configured to perform functions corresponding to steps of various methods described herein.

In an embodiment, a tangible, non-transitory computer-readable medium stores instructions that, when executed, cause a processing device to perform any operation of any method disclosed herein.

In an embodiment, a system includes a memory device storing instructions and a processing device communicatively coupled to the memory device. The processing device executes the instructions to perform any operation of any method disclosed herein.

Other technical features may be readily apparent to one skilled in the art from the following figures, descriptions, and claims.

### BRIEF DESCRIPTION OF THE DRAWINGS

FIG. 1A shows an example system configured to monitor the surroundings of a vehicle using LiDAR sensors according to the principles of the present disclosure.

FIG. 1B shows an example vertical field of view (FoV) of a sensor relative to a ground or roadway surface during calibration according to the principles of the present disclosure.

FIG. 1C shows an example implementation of a sensor in a real-world driving situation on a roadway surface according to the principles of the present disclosure.

FIG. 2A shows components of an example system configured to monitor the surroundings/environment of a vehicle and detect objects in the environment according to the principles of the present disclosure.

FIG. 2B shows example processing of LiDAR data for a sensor according to the principles of the present disclosure.

FIG. 2C shows an example of the layers 232 relative to a roadway surface 240 having a slope 242.

FIG. 3 shows a block diagram of a computer or computing system according to the principles of the present disclosure.

FIG. 4 illustrates steps of an example method for monitoring vehicle surroundings (e.g., including processing LiDAR data) according to the principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Some portions of this description describe the embodiments of the disclosure in terms of algorithms and operations. These operations are understood to be implemented by computer programs or equivalent electrical circuits, machine code, or the like, examples of which are disclosed herein. Furthermore, these arrangements of operations may be referred to as modules or units, without loss of generality. The described operations and their associated modules or units may be embodied in software, firmware, and/or hardware.

Steps, operations, or processes described may be performed or implemented with one or more hardware or software modules, alone or in combination with other devices. Although the steps, operations, or processes are described in sequence, it will be understood that in some embodiments the sequence order may differ from that which has been described, for example with certain steps, operations, or processes being omitted or performed in parallel or concurrently.

Some automotive vehicles may be equipped with a system that monitors the environment/surroundings of the vehicle and records images of the environment using LiDAR sensors. For example, the LiDAR sensors are used to monitor the environment around the vehicle and provide localization, perception, and other functions.

LiDAR sensors implement algorithms (which may be referred to herein as “LiDAR algorithms”) that are calibrated in accordance with a known situation or environment, parameters, etc. Typically, LiDAR algorithms are calibrated based on an assumption of a “flat world” with a LiDAR sensor located in a fixed location (e.g., on a front bumper of the vehicle) with zero pitch. For example, calibration may include determining a distance d in front of the vehicle at which first (e.g., ground) layers of the LiDAR sensor are expected to detect a ground surface. However, some environmental features encountered in real-world driving may result in false detection of objects when calibration is performed in this manner.

For example, when a positive (upward) slope is encountered ahead of the vehicle, the first layers will reach the upward slope of the ground surface at a shorter distance than the expected distance d. Accordingly, a positive slope and/or other features may cause false detections of objects in the path of the vehicle. As used herein, deviations from expected values, measurements, etc., such as deviations caused by slopes or other roadway characteristics may be referred to as “perturbations.”

Systems and methods according to the present disclosure are configured to process LiDAR data for localization and perception tasks based on data from a digital map, such as a stored or pre-generated high definition map (“HD map”). The HD map may include information or data about characteristics of various roadways, including slope information. For example, the HD map includes global map data, such as data obtained from a plurality of vehicles (e.g., data obtained from one or more vehicles that have previously traversed the roadways), sensors/cameras, a remote server or cloud computing system, etc. The slope information can be used to modify, compensate for, or disable sensor layers expected to reach an upward slope of the ground surface at a shorter distance than an expected distance d (e.g., the expected distance d for a flat world). Accordingly, false detection of objects caused by a sloped road surface can be minimized or eliminated.

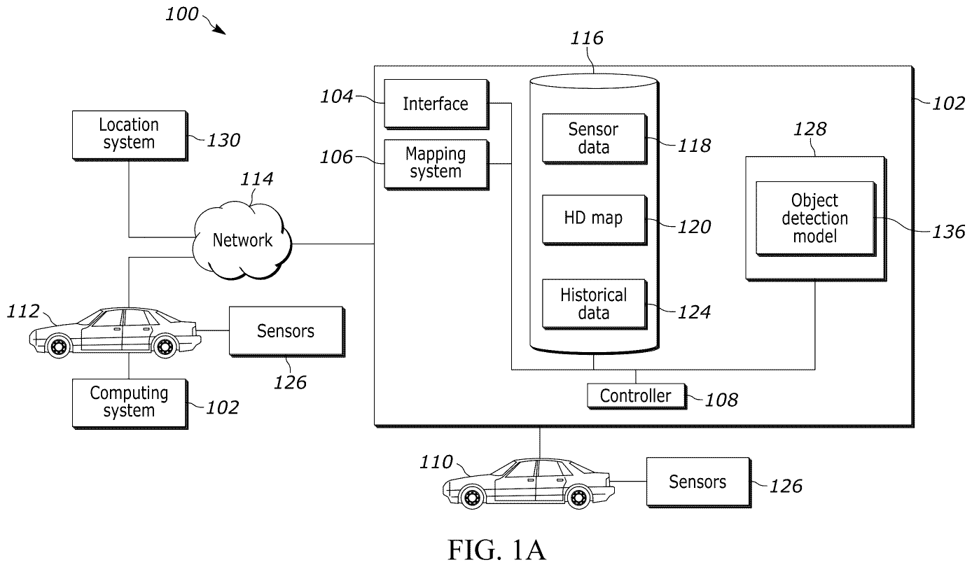

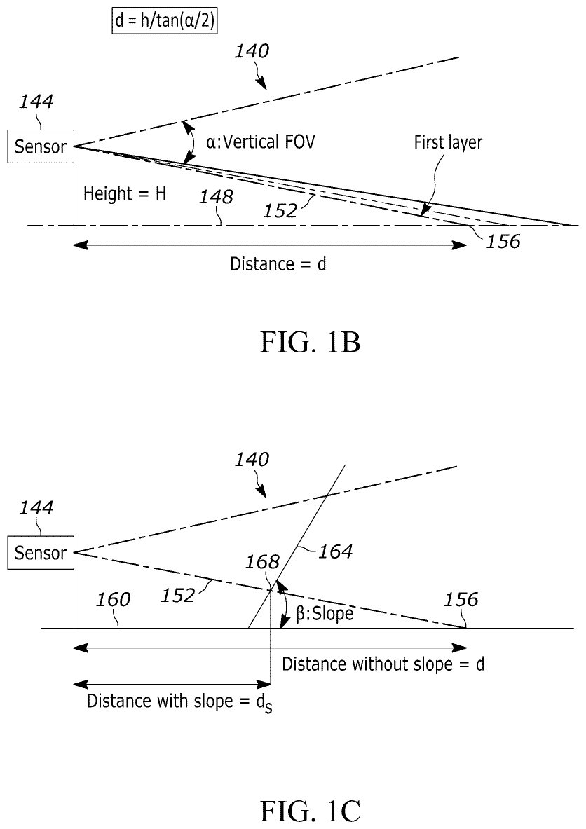

FIG. 1A illustrates a block diagram depicting an example system 100 configured to perform functions (e.g., localization functions, perception functions, etc.) for autonomous, semi-autonomous, and other driving tasks using LiDAR sensor data and global map (e.g., HD map) data according to the principles of the present disclosure. The system 100 may include at least one computing system 102 configured to perform processing of sensor data (e.g. LiDAR data) for driving tasks (e.g., using one or more machine learning models). The computing system 102 may be further configured to perform map storage, generation, and/or updating functions based on sensor data, stored data, etc.

The computing system may include at least one interface 104 and at least one mapping system 106 for generating and updating a digital, HD map, and at least one controller 108. The mapping system 106 may implement both local map data (e.g., data obtained by a vehicle traveling on a roadway, such as a first vehicle 110, using sensors to sense a local area around the vehicle) and global map data (e.g., data obtained by a plurality of vehicles, such as the first vehicle 110 and/or additional vehicles). The computing system 102 may include hardware or a combination of hardware and software, such as communications buses, circuitry, processors, communications interfaces, among others. The computing system 102 may reside on or within a corresponding vehicle (e.g., the first vehicle 110). For example, FIG. 1 shows the first vehicle 110 with the computing system 102 on-board, and a second vehicle 112 with another or similar computing system 102 on-board. Alternatively (or in addition), all or part of the computing system 102 may reside on a remote server (e.g., the cloud) which is communicatively coupled to the vehicles 110, 112 via a network 114. Each of the first vehicle 110 and the second vehicle 112 (or their corresponding computing system 102) may be communicatively connected to the network 114, to each other (e.g., via vehicle-to-vehicle (V2V) communication), to the cloud (e.g., via vehicle-to-cloud (V2C) communication), and/or to one or more other systems (e.g., a global positioning system (GPS), or to one or more communications devices).

For example, the vehicles may include one or more transceivers configured to establish a secure communication channel with another vehicle or the remote server wirelessly using one or more communication protocols, such as, for example, communication protocol based on vehicle-to-vehicle (V2V) communications, wireless local area network (WLAN) or wireless fidelity (WiFi, e.g., any variant of IEEE 802.11 including 802.11a/b/g/n), wireless personal area network (WPAN, e.g., Bluetooth, Zigbee), cellular (e.g., LTE, 3G/4G/5G, etc.), wireless metropolitan area network WIMAN (e.g., WiMax), and other wide area network, WAN technologies (e.g., iBurst, Flash-OFDM, EV-DO, HSPA, RTT, EDGE, GPRS), dedicated short range communications (DSRC), near field communication (NFC), and the like. This enables the exchange of information and data that is described herein.

The computing system 102 may also include at least one data repository or storage 116. The data repository 116 may include or store sensor data 118 (originating from the sensors described herein), a digital map or digital map data 120 (which may include an HD map including global map data as described below in more detail), and historical data 124. The sensor data 118 may include information about available sensors, identifying information for the sensors, address information, internet protocol information, unique identifiers, data format, protocol used to communicate with the sensors, or a mapping of information type to sensor type or identifier. The sensor data 118 may further include or store information collected by vehicle sensors 126. The sensor data 118 may store sensor data using timestamps and date stamps. The sensor data 118 may store sensor data using location stamps. The vehicle sensors 126 according to the present disclosure include LiDAR sensors. Accordingly, the sensor data 118 includes LiDAR sensor data used for localization, perception, etc.

Vehicle sensors 126 that generate the sensor data 118 may include one or more sensing elements or transducers that captures, acquires, records or converts information about its host vehicle or the host vehicle's environment into a form for processing. As examples, in addition to LiDAR sensors, the sensors 126 may be or include an image sensor such as a photographic sensor (e.g., camera), radar sensor, ultrasonic sensor, millimeter wave sensor, infra-red sensor, ultra-violet sensor, light detection sensor, or the like. The sensors 126 may communicate sensed data, images or recording to the computing system 102 for processing, which may include filtering, noise reduction, image enhancement, etc., followed by object recognition, feature detection, segmentation processes, and the like. The raw data originating from the sensors 126 as well as the processed data by the computing system 102 may be referred to as sensor data 118 or image data that is sensed by an associated sensors 126.

The sensors 126 can also include a global positioning system (GPS) device configured to determine a location of the host vehicle relative to an intersection. The GPS device may communicate with a location system 130, described further below. The computing system 102 may use the GPS device and the map data to determine a location of the host vehicle (e.g., the first vehicle 110) and characteristics of roadways, such as slope information, as described below in more detail. The sensors 126 may also detect (e.g., using motion sensing, imaging or any of the other sensing capabilities described herein) whether any other vehicle or object is present at or approaching an area around the vehicle, and can track any such vehicle or object's position or movement over time.

The mapping system 106 can implement visual simultaneous localization and mapping (SLAM) or similar technologies to generate a digital map. The mapping system 106 is configured to generate digital map data based on the data sensed by the one or more sensors 126. The digital map data structure (which may be referred to as the HD map 120) may generate the digital map from, with, or using one or more machine learning models or neural networks established, maintained, tuned, or otherwise provided via one or more machine learning models 128. The machine learning models 128 can be configured, stored, or established on the computing system 102 of the first vehicle 110 and/or on a remote server. The machine learning models 128 are configured to detect, from a first neural network and based on the data sensed by the one or more sensors 126, objects in the environment around the first vehicle 110. The machine learning models 128 may, using the first neural network and based on the data sensed by the one or more sensors 126, perform scene segmentation, obtain depth information, and so on.

The mapping system 106 may create the HD map 120 based on the sensor data 118. The HD map 120 can be created via implemented visual SLAM, as described above. In one embodiment, the HD map 120 may include three dimensions on an x-y-z coordinate plate, and associated dimensions can include latitude, longitude, and range, for example. The HD map 120 may be updated periodically or reflect or indicate a motion, movement or change in one or more detected objects in the environment. The HD map 120 according to the present disclosure may also include information about various characteristics of roadways.

Various types of the machine learning models 128 are disclosed herein. The machine learning model utilized by the mapping system 106 to generate the HD map 120 can include any type of neural network, including, for example, a convolution neural network, deep convolution network, a feed forward neural network, a deep feed forward neural network, a radial basis function neural network, a Kohonen self-organizing neural network, a recurrent neural network, a modular neural network, a long/short term memory neural network, or the like. Each of the machine learning models 128 can maintain, manage, store, update, tune, or configure one or more neural networks and can use different parameters, weights, training sets, or configurations for each of the neural networks to allow the neural networks to efficiently and accurately process a type of input and generate a type of output.

One or more of the disclosed machine learning models 128 disclosed herein may be configured as or include a convolution neural network. The convolution neural network (CNN) can include one or more convolution cells (or pooling layers) and kernels, that may each serve a different purpose. The convolution kernel may process input data, and the pooling layers may simplify the data, using, for example, non-linear functions such as a max, thereby reducing unnecessary features. The CNN may facilitate image recognition. For example, the sensed input data may be passed to convolution layers that form a funnel, compressing detected features. The first layer may detect first characteristics, the second layer may detect second characteristics, and so on. In some examples described herein, the first layer may be configured to process LiDAR sensor data corresponding to detection of a ground or roadway surface.

The convolution neural network may be a type of deep, feed-forward artificial neural network configured to analyze visual imagery. The convolution neural network may include multilayer perceptrons designed to use minimal preprocessing. The convolution neural network may include or be referred to as shift invariant or space invariant artificial neural networks, based on their shared-weights architecture and translation invariance characteristics. Since convolution neural networks may use relatively less pre-processing compared to other image classification algorithms, the convolution neural network may automatically learn the filters that may be hand-engineered for other image classification algorithms, thereby improving the efficiency associated with configuring, establishing or setting up the neural network, thereby providing a technical advantage relative to other image classification techniques.

One or more of the disclosed machine learning models 128 disclosed herein may include a CNN having an input layer and an output layer, and one or more hidden layers that can include convolution layers, pooling layers, fully connected layers, or normalization layers. The one or more pooling layers may include local pooling layers or global pooling layers. The pooling layers may combine the outputs of neuron clusters at one layer into a single neuron in the next layer. For example, max pooling may use the maximum value from each of a cluster of neurons at the prior layer. Another example is average pooling, which may use the average value from each of a cluster of neurons at the prior layer. The fully connected layers may connect every neuron in one layer to every neuron in another layer.

To assist in generating the HD map 120, the computing system 102 may interface or communicate with the location system 130 via network 114. The location system 130 is configured to determine and communicate the location of one or more of the vehicles 110, 112 during the performance of the SLAM or similar mapping techniques executed in generating the HD map 120. The location system 130 may include any device based on a positioning system such as Global Navigation Satellite System (GNSS), which may include GPS, GLONASS, Galileo, Beidou and/or other regional systems. The location system 130 may include one or more cellular towers to provide triangulation. The location system 130 may include wireless beacons, such as near field communication beacons, short-range wireless beacons (e.g., Bluetooth beacons), or Wi-Fi modules.

The computing system 102 may be configured to utilize the interface 104 to receive and transmit information. The interface 104 may receive and transmit information using one or more protocols, such as a network protocol. The interface 104 may include a hardware interface, software interface, wired interface, or wireless interface. The interface 104 may facilitate translating or formatting data from one format to another format. For example, the interface 104 may include an application programming interface that includes definitions for communicating between various components, such as software components. The interface 104 may be designed, constructed or operational to communicate with one or more sensors 126 to collect or receive information, e.g., image data. The interface 104 may be designed, constructed or operational to communicate with the controller 108 to provide commands or instructions to control a vehicle, such as the first vehicle 110. The information collected from the one or more sensors may be stored as shown by sensor data 118.

The interface 104 may receive the image data sensed by the one or more sensors 126 regarding an environment or characteristics of the environment around the vehicle 110. The sensed data received from the sensors 126 may include data detected, obtained, sensed, collected, or otherwise identified by the sensors 126. As explained above, the sensors 126 may be one or more various types of sensors, and therefore the data received by the interface 104 for processing can be data from a camera, data from an infrared camera, LiDAR data, laser-based sensor data, radar data, transducer data, or ultrasonic sensor data. Because this data can, when processed, enable information about the environment to be visualized, this data may be referred to as image data.

The data sensed from the sensors 126 may be received by interface 104 and delivered to mapping system 106 for detecting various qualities or characteristics of a roadway as explained above utilizing techniques such as segmentation, CNNs, or other machine learning models. The data sensed from the sensors 126 may further be used by the computing device 102 for detecting objects in a roadway while the vehicle 110 is driving (e.g., in real-time). As an example, the controller 108 may be configured to implement the object detection model 136 to perform various automated or semi-automated driving tasks. The controller 108 can use the object detection model 136 to perform scene segmentation, to detect objects, roads, terrain, trees, curbs, obstacles, depth or range, etc. associated with a roadway, and so on.

The computing system 102 can train the machine learning models 128 using the historical data 124. This training may be performed using the computing system 102 installed on a vehicle or located remotely. For example, the computing system 102 may be located on a remote server for at least these purposes. Once trained, the various machine learning models may be communicated to or loaded onto the vehicles 110, 112 via the network 114 for execution.

Once generated, the HD map 120 may be stored in storage 116 and accessed by other vehicles. For example, the computing system 102 of a first vehicle 110 may be utilized to at least in part generate the HD map 120, whereupon that HD map 120 can be accessed by the computing system 102 of a second vehicle 112 that subsequently travels on a corresponding roadway. The computing system 102 of the second vehicle 112 (and other vehicles) can be utilized to update the HD map 120 in real-time based upon more reliable data captured from the second vehicle 112. In addition, the computing system 102 of both vehicles 110, 112 can be used to generate and continuously update the HD map 120 in real-time. The HD map 120 includes data indicating characteristics of particular roadways, such as slope information. These qualities of the individual roadways can be determined via the image data received from sensors 126 either when the digital map is generated, and/or when the digital map is updated by a second vehicle 112 or other vehicles. By updating the HD map 120 in real-time, a subsequent vehicle traveling on a roadway can be provided with live, accurate information about characteristics of the roadway.

As described above, calibrating LiDAR algorithms (e.g., for the sensors 126 that may correspond to LiDAR sensors) based on an assumption of a “flat world” includes determining a distance d in front of the vehicle at which first (e.g., ground) layers of the LiDAR sensor are expected to detect a ground surface. However, when a positive (upward) slope is encountered ahead of the vehicle, the first layers will reach the upward slope of the ground surface at a shorter distance than the expected distance d. Accordingly, a positive slope and/or other features may cause false detections of objects in the path of the vehicle.

FIG. 1B shows an example vertical field of view (FoV) 140 of a sensor 144 relative to a ground or roadway surface 148 during calibration (e.g., during calibration on a “flat” roadway without a detectable positive/upward slope). A lower boundary 152 of the FoV corresponds to first (e.g., ground) layer of sensor data. In this example, calibration is performed based on an assumption of a “flat world.” In other words, since the roadway surface 148 is substantially flat, values obtained during calibration correspond specifically to flat roadway surfaces. As one example, a distance d from the sensor 144 (e.g., a sensor in fixed location with zero pitch) to a point 156 in front of the vehicle at which the first layer reaches the roadway surface 148 is determined. Accordingly, the distance d corresponds to a distance at which the first layer is expected to reach the roadway surface 148 during subsequent operation of the sensor 144.

FIG. 1C shows an example implementation of the sensor 144 in a real-world driving situation on a roadway surface 160. In this example, the roadway surface 160 includes a positive/upward slope 164. As calibrated (as described with respect to FIG. 1B), the first layer of the sensor 144 is expected to reach the roadway surface 160 at the point 156. However, due to the upward slope 164, the first layer reaches the roadway surface 160 at a point 168 on the slope 164. Accordingly, the first layer reaches the roadway surface 160 (e.g., at the point 168 on the slope 164) at a distance dₛ. Since the distance dₛ (a “distance with slope”) is less/shorter than the expected distance d, a surface of the slope 164 may be identified (e.g., by the controller 108, implementing the object detection model 136) as an object in the roadway.

Systems and methods according to the present disclosure are configured to process LiDAR data obtained from sensors (e.g., the sensor 144) further based on data from the HD map 120 to minimize or eliminate false detection of objects caused by the slopes in the roadway, such as the slope 164. As described above, the HD map 120 may include information or data about characteristics of various roadways, including slope information. For example, the HD map 120 includes data identifying characteristics of the slope 164 (e.g., slope information) on a corresponding roadway, as well as other slopes on other roadways. The slope information may include information such as an angle β of the slope relative to a flat portion of the roadway. The slope information can be used to modify, compensate for, or disable sensor layers expected to reach the slope 164 at a shorter distance than the expected distance d as described below in more detail.

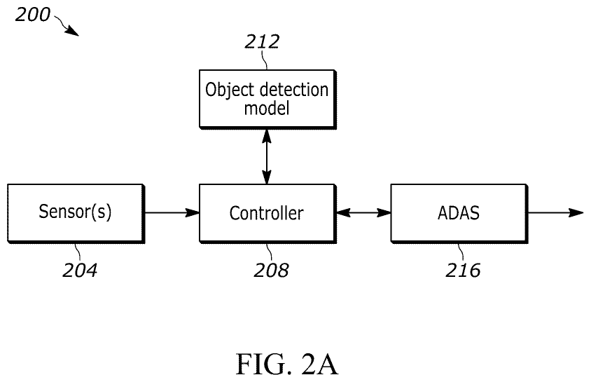

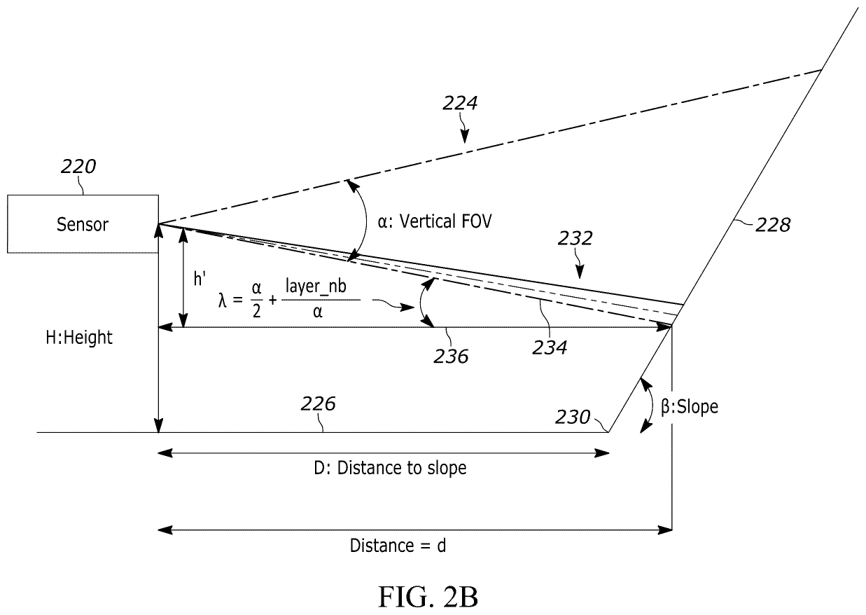

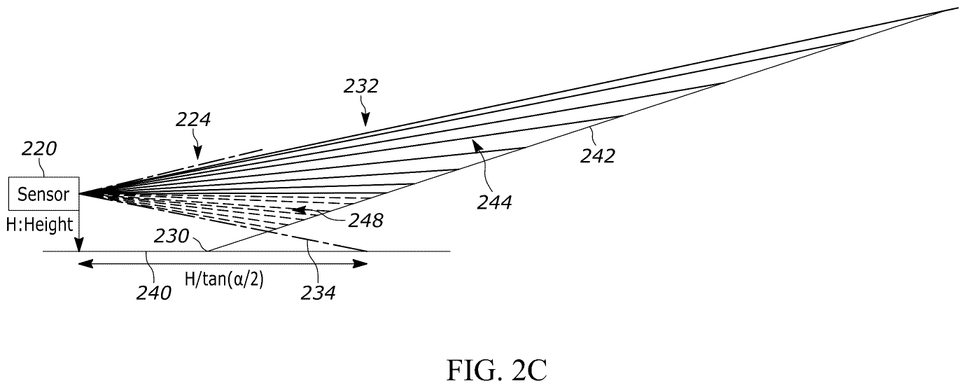

FIG. 2A shows components of an example system 200 (e.g., as implemented within and/or by the computing device 102, the first vehicle 110, etc.) configured to monitor the surroundings/environment of a vehicle and detect objects in the environment using sensors (e.g., LiDAR sensors) 204 and a controller 208 according to the principles of the present disclosure. For example, the sensors 204 correspond to the sensors 126 of FIG. 1A and the controller 208 corresponds to the controller 108 of FIG. 1A. As one example, the controller 208 corresponds to an engine control unit (ECU).

Data from the sensors 204 may be used for various driving tasks by providing localization, perception, and other functions. For example, the sensors 204 target objects or surfaces in the environment with a laser (or, a “laser signal,” “light signal,” etc.) and measure an amount of time for reflected light to return to the sensors 204. The controller 208 is configured to receive outputs of the sensors 204 (“sensor outputs”) and generate one or more signals indicative of objects in the environment based on the sensor outputs. For example, the controller 208 may include and/or may be configured to implement all or portions of an object detection model 212 (e.g., corresponding to the object detection model 136 of FIG. 1A). The object detection model 212 is configured to receive the sensor outputs and detect objects in the environment based on the sensor outputs in accordance with various object detection techniques.

The controller 208 is configured to perform one or more actions in response to detection of objects in the environment. For example, the controller 208 may be configured to control various functions of the vehicle (e.g., autonomous or semi-autonomous driving functions) in response to detecting objects in the environment. As one example, the controller 208 may communicate with, include, and/or be configured to implement all or portions of an advance driver assistance system (ADAS) 216. For example, the ADAS 216 includes various components such as sensors (e.g., the sensors 204), controllers, actuators, circuitry, software, etc. configured to implement autonomous, semi-autonomous, and/or driver assistance tasks. These tasks may include, but are not limited to, tasks associated with steering cruise control, acceleration and deceleration, braking, blind spot monitoring, parking, land departure warnings and/or driver alerts, etc. Accordingly, the ADAS 216 may implement and/or be responsive to object detection functions and perform or assist in various tasks based on objects detected in the roadway (e.g., responsive to outputs of the object detection model 212). Components of the system 200 (e.g., the controller 208, the object detection model 212, the ADAS 216, etc.), collectively and/or individually, are configured to operate further based on slope information (e.g., data from the HD map 120) to minimize or eliminate false detection of objects caused by slopes in the roadway as described below in more detail.

Example processing of LiDAR data for a sensor 220 (e.g., corresponding to one of the sensors 204) according to the principles of the present disclosure is described in FIG. 2B. The sensor 220 has an example vertical field of view (FoV) 224 relative to a ground or roadway surface 226 that includes a slope 228. The FoV 224 has an associated FoV angle α. The slope 228 has a slope or incline angle β relative to a flat portion of the roadway surface 226.

In an example, the angle β is obtained from the HD map data as described herein (e.g., as contained within the HD map 120). For example, previously obtained slope information and other information indicating characteristics of various roadways may be stored within the HD map 120. Accordingly, when a vehicle is traveling on a roadway, approaching slopes and other features of the roadway can be determined by the system 200 from the HD map 120 prior to the vehicle actually reaching the slopes (e.g., using GPS and/or other data). In other examples, slopes in the roadway may be identified in real-time as the vehicle approaches the slopes. A distance D to a start of the slope 228 (e.g., shown at 230) may also be known (e.g., based on a determined position and lane of the vehicle relative to a known position or location of the slope 228 on the roadway, based on detection of the start of the slope using the sensor 220, etc.). Other values may be known or predetermined (e.g., as contained within the HD map 120) or readily obtained, such as a height H of the sensor 220 relative to the roadway surface 226.

The sensor 220 has a plurality of (i.e., multiple) layers 232, corresponding to different layers of data obtained from the environment. Although only three (3) of the layers are shown, the sensor 220 may be implemented with any number of layers (e.g., layers 0, 1, 2, . . . , and n). As described herein, a lowest layer 234 (i.e., a layer nearest to the roadway surface 226) of the layers 232 will be referred to as a layer 0. Successive layers (i.e., next highest layers relative to the lowest layer 234) will be referred to as a layer 1, a layer 2, . . . , and a layer n. In some examples, the layers 232 correspond to one or more lasers deflected in multiple directions within the FoV 224 (e.g., using a rotating mirror). In other examples, the layers 232 correspond to one or more oscillating lasers. In still other examples, the layers 232 correspond to a plurality of laser emitters configured to emit respective lasers and generate respective layers. The system 200 according to the present disclosure is configured to disable selected layers 232 (e.g., remove from consideration for object detection) expected to reach the slope 228 of the ground surface at a shorter distance than an expected distance (e.g., the expected distance for a flat world as described above).

A distance d to the slope 228 for each of the layers 232 can be calculated based on known values (e.g., values obtained from the HD map 120), calculated or measured values, or combinations thereof. For example, the distance d for a given layer corresponds to a distance between the sensor 220 to a point on the slope 228 targeted by the layer. In one example, a distance d from the sensor 220 to the slope 228 for a given layer L (e.g., a layer 0, 1, . . . , n) can be calculated according to:

$$d = \frac{tan ( \frac{π}{2} - β ) H}{1 + tan ( \frac{π}{2} - β ) tan ( λ / 2 )} . \qquad ( Equation 1 )$$

In the above Equation 1, the angle λ corresponds to an angle between the layer L and a line or plane 236 parallel to the roadway surface 226 and can be calculated according to:

$$λ = \frac{α}{2} + \frac{L}{α} . \qquad ( Equation 2 )$$

The Equation 1 can be derived based on a height h′, which corresponds to a distance between the line 236 (which is positioned at a height at which the lowest layer 234 reaches the slope 228) and the height H of the sensor 220. For example, the height h′ can be calculated according to:

$${h}^{′} = tan ( \frac{λ}{2} ) * d . \qquad ( Equation 3 )$$

Using the height h′, Equation 1 can be derived as follows:

$$( d - D ) = tan ( \frac{π}{2} - β ) * ( H - {h}^{′} ) ; and \qquad ( Equation 4 )$$

$$d = tan ( \frac{π}{2} - β ) * H - tan ( \frac{π}{2} - β ) * {h}^{′} . \qquad ( Equation 5 )$$

With the distance d obtained for each of the layers 232, selected layers may be disregarded for object detection based on respective values for the distance d. In other words, based on knowledge of the characteristics of the slope 228, the system 200 is configured to determine which of the layers 232 will provide data indicating that the slope 228, not an object in the roadway 226, has been identified/detected. Layers that are simply representative of the sensor 220 detecting the slope 228 (e.g., lower layers) will not be considered for object detection while layers above the lower layers (e.g., upper layers) will continue to be considered for object detection.

The layers may be selectively considered or disregarded based on a distance threshold dₜ. For example, the distance threshold may be calculated based on the expected distance for the lowest layer 234 to reach a roadway surface in a flat world as described above in more detail. In one example, the distance threshold dₜ may be calculated in accordance with dₜ=H/tan(α/2), and a given layer is considered during object detection in response to the following condition (e.g., a distance condition) being met:

$$d \geq H / tan ( α / 2 ) .$$

In other words, layers that do not meet the condition d≥H/tan(α/2) are disregarded/ignored by the system 200 (e.g., the controller 208, the object detection model 212, etc.).

Determination of whether to use respective layers 232 may further depend upon whether any objects are detected by a given layer prior to the start of the slope 228 (i.e., detected between the sensor 220 and the start of the slope 228). In other words, if a given layer detects an object at a distance less than the distance d for that layer, then that layer is not ignored regardless of whether the layer satisfies the condition d≥H/tan(α/2).

FIG. 2C shows an example of the layers 232 relative to a roadway surface 240 having a slope 242. In this example, there are sixteen (16) of the layers 232 (layers 0 through 15). In this example, each of layers 244 (shown as solid lines) have a respective distance d that satisfies the condition d≥H/tan(α/2). Accordingly, the layers 244 are considered for object detection. In other words, sensor data corresponding to the layers 244 is provided as input to the object detection model 212 for localization and perception tasks.

Conversely, each of layers 248 (shown as dotted/dashed lines) have a respective distance d that does not satisfy the condition d≥H/tan(α/2). Accordingly, the layers 248 are not considered for object detection and instead are disregarded/ignored. In other words, sensor data corresponding to the layers 248 is not provided as input to the object detection model 212 for localization and perception tasks.

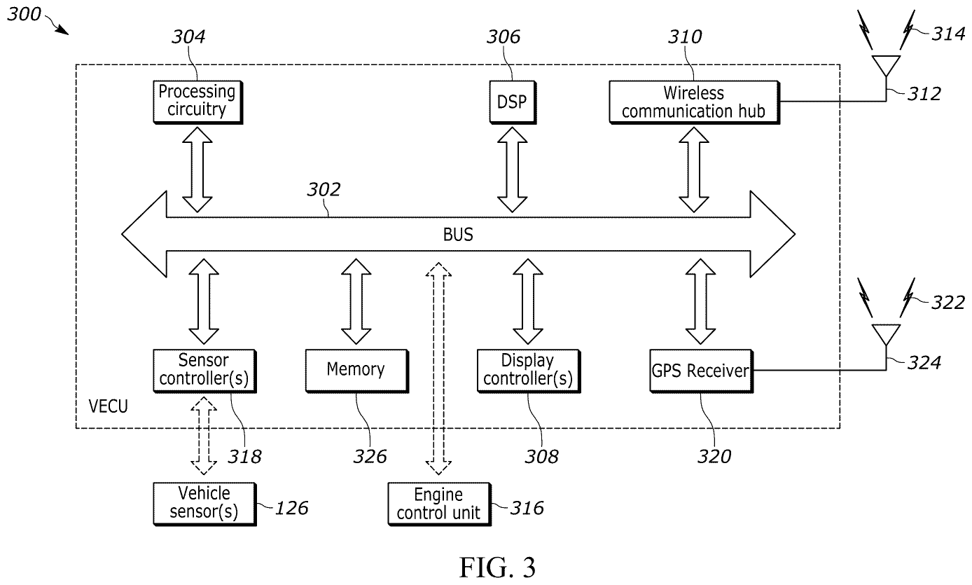

FIG. 3 is a block diagram of internal components of an exemplary embodiment of a computer or computing system 300 configured to implement the systems and methods described above. In this embodiment, the computing system 300 may be embodied at least in part in an ECU, vehicle electronics control unit (VECU), controller, or other computing system of a vehicle, such as the vehicle 110 of FIG. 1A. It should be noted that FIG. 3 is meant only to provide a generalized illustration of various components, any or all of which may be utilized as appropriate. It can be noted that, in some instances, components illustrated by FIG. 3 can be localized to a single physical device and/or distributed among various networked devices, which may be disposed at different physical locations.

The computing system 300 has hardware elements that can be electrically coupled via a BUS 302. The hardware elements may include processing circuitry 304 which can include, without limitation, one or more processors, one or more special-purpose processors (such as digital signal processing (DSP) chips, graphics acceleration processors, application specific integrated circuits (ASICs), and/or the like), and/or other processing structure or means. The above-described processors can be specially-programmed to perform the operations disclosed herein, including, among others, image processing, data processing, and implementation of the machine learning models described above. Some embodiments may have a separate DSP 306, depending on desired functionality. The computing system 300 can also include one or more display controllers 308, which can control the display devices disclosed above, such as an in-vehicle touch screen, screen of a mobile device, and/or the like.

The computing system 300 may also include a wireless communication hub 310, or connectivity hub, which can include a modem, a network card, an infrared communication device, a wireless communication device, and/or a chipset (such as a Bluetooth device, an IEEE 802.11 device, an IEEE 802.16.4 device, a WiFi device, a WiMax device, cellular communication facilities including 4G, 5G, etc.), and/or the like. The wireless communication hub 310 can permit data to be exchanged with the network 114, wireless access points, other computing systems, etc. The communication can be carried out via one or more wireless communication antenna 312 that send and/or receive wireless signals 314.

The computing system 300 can also include or be configured to communicate with an engine control unit 316, or other type of controller described herein. In the case of a vehicle that does not include an internal combustion engine, the engine control unit may instead be a battery control unit or electric drive control unit configured to command propulsion of the vehicle. In response to instructions received via the wireless communications hub 310, the engine control unit 316 can be operated in order to control the movement of the vehicle during, for example, a parking extraction task.

The computing system 300 also includes vehicle sensors 126 such as the sensors 204 described above with reference to FIGS. 2A, 2B, and 2C. Sensors can include, without limitation, one or more accelerometer(s), gyroscope(s), camera(s), radar(s), LiDAR(s), odometric sensor(s), and ultrasonic sensor(s), as well as magnetometer(s), altimeter(s), microphone(s), proximity sensor(s), light sensor(s), and the like. These sensors can be controlled via associated sensor controller(s) 318.

The computing system 300 may also include a GPS receiver 320 configured to receive signals 322 from one or more GPS satellites using a GPS antenna 324. The GPS receiver 320 can extract a position of the device, using conventional techniques, from satellites of an GPS system, such as a global navigation satellite system (GNSS) (e.g., Global Positioning System (GPS)), Galileo, GLONASS, Compass, Galileo, Beidou and/or other regional systems and/or the like.

The computing system 300 can also include or be in communication with a memory 326. The memory 326 can include, without limitation, local and/or network accessible storage, a disk drive, a drive array, an optical storage device, a solid-state storage device, such as a RAM which can be programmable, flash-updateable and/or the like. Such storage devices may be configured to implement any appropriate data stores, including without limitation, various file systems, database structures, and/or the like. The memory 326 can also include software elements (not shown), including an operating system, device drivers, executable libraries, and/or other code embedded in a computer-readable medium, such as one or more application programs, which may comprise computer programs provided by various embodiments, and/or may be designed to implement methods, and/or configure systems, provided by other embodiments, as described herein. In an aspect, then, such code and/or instructions can be used to configure and/or adapt a general purpose computer (or other device) to perform one or more operations in accordance with the described methods, thereby resulting in a special-purpose computer.

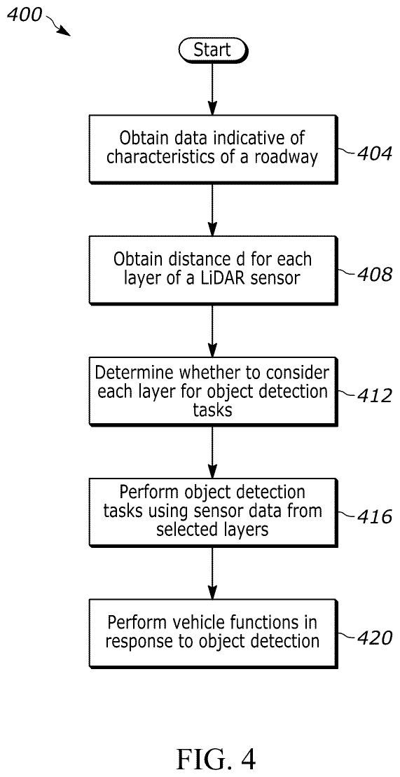

FIG. 4 illustrates steps of an example method 400 for processing LiDAR sensor data for various tasks (e.g., object detection tasks) as described herein. One or more computing devices, controllers, systems, processors or processing devices, circuitry, etc. as described herein may be configured to perform the method 400. For example, a controller such as the controller 108, operating within the system 100, all or portions of which may be implemented within a vehicle, is configured to perform the method 400. Although described below with respect to object detection, variations of the method 400 may be performed for other tasks, such as mapping, localization, etc. Accordingly, various tasks or functions that include object detection, mapping, localization, and/or other environment analyzation tasks may be generally referred to as “perception” or perception tasks/functions.

At 404, the method 400 includes obtaining data indicative of characteristics of a roadway (e.g., a roadway a vehicle is currently traveling on). In one example, the data is obtained from previously obtained map data that identifies the characteristics of the roadway, such as slope information that includes at least locations of slopes in the roadway and angles of the slopes.

At 408, the method 400 includes obtaining a respective distance d for each of a plurality of layers of at least one LiDAR sensor configured to scan the environment around the vehicle, such as a LiDAR sensor configured to scan the roadway in front of the vehicle. In one example, the distance d is obtained using Equation 1 described herein. The distance may be calculated in real-time (e.g., prior to a vehicle reaching a given slope, a predetermined distance before the vehicle reaches the slope, etc.) and/or may be previously obtained and stored (e.g., within the HD map 120).

At 412, the method 400 includes determining, based on the distance d each of the layers, whether to consider the layer for object detection tasks. For example, determining whether to consider a given layer may include determining whether the distance d satisfies a condition, such as a distance threshold. In one example, determining whether to consider a layer includes determining whether the distance d satisfies the condition d≥H/tan(α/2).

At 416, the method 400 includes performing object detection tasks (e.g., localization, perception, etc.) using the layers that satisfy the condition as described above in step 412 (e.g., “selected layers”). For example, sensor data corresponding to the layers that satisfy the condition is provided as inputs to an object detection model. Conversely, sensor data corresponding to the layers that do not satisfy the condition (e.g., “unselected layers”) are not provided as inputs to the object detection model.

At 420, the method 400 includes performing one or more vehicle functions or tasks (e.g., autonomous, semi-autonomous, or driver assistance tasks) in response to the object detection performed in step 416.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These memory devices may be non-transitory computer-readable storage mediums for storing computer-executable instructions which, when executed by one or more processors described herein, can cause the one or more processors to perform the techniques described herein. The processor and the memory can be supplemented by, or incorporated in, special purpose logic circuitry.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method performed by a controller of a vehicle, the method comprising:
obtaining slope information corresponding to a slope of a roadway;
obtaining, for each layer of a plurality of layers of at least one sensor configured to emit laser signals into an environment around the vehicle, a respective distance d corresponding to a distance between the at least one sensor and a point on the slope targeted by the layer;
identifying, based on the respective distances d associated with the plurality of layers, one or both of a selected layer and an unselected layer;
performing one or more perception functions using sensor data corresponding to any identified selected layers without using sensor data corresponding to the unselected layer; and
controlling at least one function of the vehicle based on results of the one or more perception functions.

2. The method of claim 1, wherein the slope information includes at least one of a location of the slope on the roadway and an angle associated with the slope.

3. The method of claim 1, wherein the at least one sensor is a light detection and ranging (LiDAR) sensor.

4. The method of claim 1, wherein identifying the one or both of the selected layer and the unselected layer includes determining whether each of the plurality of layers satisfies a distance condition.

5. The method of claim 4, wherein determining whether each of the plurality of layers satisfies the distance condition includes determining whether each distance d is greater than or equal to a distance threshold.

6. The method of claim 5, wherein the selected layer corresponds to a layer having a respective distance d that is greater than or equal to the distance threshold.

7. The method of claim 5, wherein the unselected layer corresponds to a layer having a respective distance d that is less than the distance threshold.

8. The method of claim 5, wherein the distance threshold corresponds to H/tan(α/2), where H corresponds to a height of the at least one sensor relative to the roadway and a corresponds to a field of view of the at least one sensor.

9. The method of claim 1, wherein the respective distance d corresponds to
$$d = \frac{tan ( \frac{π}{2} - β ) H}{1 + tan ( \frac{π}{2} - β ) tan ( λ / 2 )} ,$$
where H corresponds to a height of the at least one sensor relative to the roadway, β corresponds to an angle associated with the slope, and λ corresponds to an angle associated with the layer.

10. A system configured to control at least one function of a vehicle based on perception of an environment around the vehicle, the system comprising:
at least one sensor arranged on the vehicle, wherein the at least one sensor is configured to emit laser signals into the environment; and
a controller configured to
obtain slope information corresponding to a slope in a roadway,
obtain, for each layer of a plurality of layers of the at least one sensor, a respective distance d corresponding to a distance between the at least one sensor and a point on the slope targeted by the layer,
identify, based on the respective distances d associated with the plurality of layers, one or both of a selected layer and an unselected layer,
perform one or more perception functions using sensor data corresponding to any identified selected layers without using sensor data corresponding to the unselected layer,
and
control the at least one function of the vehicle based on results of the one or more perception functions.

11. The system of claim 10, wherein the slope information includes at least one of a location of the slope on the roadway and an angle associated with the slope.

12. The system of claim 10, wherein the at least one sensor is a light detection and ranging (LiDAR) sensor.

13. The system of claim 10, wherein identifying the one or both of the selected layer and the unselected layer includes determining whether each of the plurality of layers satisfies a distance condition.

14. The system of claim 13, wherein determining whether each of the plurality of layers satisfies the distance condition includes determining whether each distance d is greater than or equal to a distance threshold.

15. The system of claim 14, wherein the selected layer corresponds to a layer having a respective distance d that is greater than or equal to the distance threshold.

16. The system of claim 14, wherein the at unselected layer corresponds to a layer having a respective distance d that is less than the distance threshold.

17. The system of claim 14, wherein the distance threshold corresponds to H/tan(α/2), where H corresponds to a height of the at least one sensor relative to the roadway and α corresponds to a field of view of the at least one sensor.

18. The system of claim 10, wherein the respective distance d corresponds to
$$d = \frac{tan ( \frac{π}{2} - β ) H}{1 + tan ( \frac{π}{2} - β ) tan ( λ / 2 )} ,$$
where H corresponds to a height of the at least one sensor relative to the roadway, β corresponds to an angle associated with the slope, and λ corresponds to an angle associated with the layer.

19. A processor configured to execute instructions stored on a non-transitory computer-readable medium, wherein executing the instructions causes the processor to:
obtain slope information corresponding to a slope of a roadway;
obtain, for each layer of a plurality of layers of a sensor configured to emit laser signals into an environment around a vehicle, a respective distance d corresponding to a distance between the sensor and a point on the slope targeted by the layer;
identify, based on the respective distances d associated with the plurality of layers, one or both of a selected layer and an unselected layer;
perform one or more perception functions using sensor data corresponding to any identified selected layers without using sensor data corresponding to the unselected layer; and
control at least one function of the vehicle based on results of the one or more perception functions.

20. The processor of claim 19, wherein the slope information includes at least one of a location of the slope on the roadway and an angle associated with the slope, wherein identifying the selected layer and the unselected layer includes determining whether each of the plurality of layers satisfies a distance condition, and wherein determining whether each of the plurality of layers satisfies the distance condition includes determining whether the respective distance d is greater than or equal to a distance threshold.
